(19) United States
(12) Patent Application Publication
(10) Pub. No.: US 2006/0244752 A1
(43) Pub. Date: Nov. 2, 2006

(54) SIGNAL CONVEYING APPARATUS AND DISPLAY SYSTEM HAVING SAME

(76) Inventors: Kuan-Hong Hsieh, Guangdong (CN); Xiao-guang Li, Guangdon (CN); Shin-Hong Chung, Guangdong (CN)

Correspondence Address: NORTH AMERICA INTELLECTUAL PROPERTY CORPORATION, P.O. BOX 506, MERRIFIELD, VA, 22116, US

(21) Appl. No.: 11/308,315

(22) Filed: Mar. 16, 2006

(30) Foreign Application Priority Data
Apr. 29, 2005 (CN) 200510034507.X

(51) Int. Cl. G06F 13/14

(52) U.S. Cl. 345/520

(57) ABSTRACT

A signal conveying apparatus (20) connects with a power supply unit (10) and a display device (30). The signal conveying apparatus includes a plurality of input interfaces (221), a signal converting unit (24), and an output interface (261). The input interfaces receive signals from external electronic devices. The signal converting unit integrates and converts the signals received by the input interfaces to a format that can be received by the display device. The output interface receives the converted signals from the signal converting unit and outputs the converted signals to the display device.

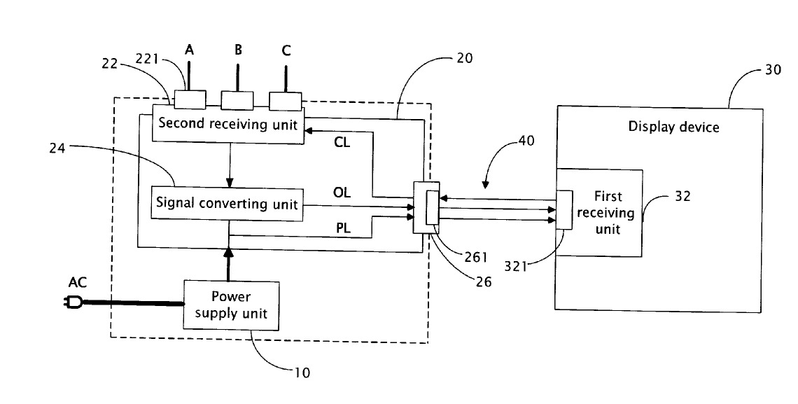

### DESCRIPTION

1. Technical Field

The present invention relates to peripheral apparatuses of display devices, and particularly to a signal conveying apparatus which converts signals into a format that can be received by a display device.

2. Related Art

Display devices are widely used in applications such as displays for computers and televisions in the home. Computer displays and home televisions have an advantage over many other electronic devices, as they usually have a large screen to display images originally received in the form of video signals. This enables users to view pictures and information more clearly. In addition, many kinds of audio/video signal recording apparatuses, storing apparatuses, and playing apparatuses have been developed. These apparatuses widely include VCD/DVD players, digital cameras, digital video cameras, MP3 (MPEG Audio Layer 3) players, and cell phones.

A user sometimes needs to convey information between respective of these electronic devices. For example, a user may like to show pictures stored in a digital camera via a display device (e.g. a television). Sometimes the user may like to show text or characters (i.e. captions) together with the pictures, and the text may be stored in another electronic device such as a personal computer. Therefore, the user needs to connect both the camera and the personal computer to the display device. However, the display device may not possess enough interfaces for such connections, or the interfaces may not be compatible with the camera and/or the personal computer. Further, even if there are enough compatible interfaces, it might not be possible to have the pictures and the text displayed on the display device in an integrated, coordinated manner unless the corresponding video and text signals have been integrated before being sent to the display device.

Therefore, there is a need for a signal conveying apparatus which can increase the number of external electronic devices that can be connected to a display device simultaneously, convert signals from the external electronic devices into a format that can be received by the display device, and integrate the signals from the external electronic devices to enable the simultaneous display of media from plural sources.

### SUMMARY

A signal conveying apparatus is provided. In a preferred embodiment, the signal conveying apparatus includes: a plurality of input interfaces, each connects with an electronic device and receives signals from the electronic device; an output interface connected with a display device and output signals to the display device in a format that the display device is capable of receiving; and a signal converting unit for converting signals received by the input interfaces into the format receivable by the display device and outputting the converted signals to the display device via the output interface. The display device sends a command indicative of the receivable format to the signal conveying apparatus, and the signal converting unit converts the signals from the input interfaces into the receivable format upon receiving the command. The signal conveying apparatus further divides the signals from the input interfaces into several parts, selects one or more parts to integrate and convert into the receivable format.

A display system installed with a signal conveying apparatus is also provided. The display system includes: a display device including a receiving interface, the display device being capable of receiving signals of a certain format via the receiving interface; and the signal conveying apparatus. The signal conveying apparatus includes: a plurality of input interfaces, each for connecting with an electronic device and receives signals from the electronic device; a signal converting unit for converting signals received by the input interfaces into the format receivable by the display device; and an output interface connected with the signal converting unit and the display device, the output interface outputting the converted signals from the signal converting unit to the display device. The display device sends a command indicative of the receivable format to the signal conveying apparatus, and then the signal converting unit converts the signals from the input interfaces into the receivable format according to the command. The signal conveying apparatus further divides the signals from the input interfaces into several parts, selects one or more parts to integrate, and converts the selected parts into the receivable format.

Via the signal conveying apparatus, a plurality of external electronic devices can be connected to the display device for successful presentation of a variety of digital media. Further, via the signal conveying apparatus, signals from different information sources (e.g., the DV and the DVD player) can be integrated and converted into one format, and thus be displayed on the display device 30 simultaneously.

Other advantages and novel features will be drawn from the following detailed description with reference to the attached drawing.

### BRIEF DESCRIPTION OF DRAWING

The drawing is a block diagram of a signal conveying apparatus in accordance with a preferred embodiment of the present invention, the apparatus being connected with a display device and a power supply unit.

### DETAILED DESCRIPTION OF THE EMBODIMENTS

Referring to the drawing, this shows a signal conveying apparatus 20 in accordance with a preferred embodiment of the present invention. The signal conveying apparatus 20 connects with a display device 30. The signal conveying apparatus 20 and the display device 30 both receive electrical power from a power supply unit 10 via power lines symbolically shown as PL. The power supply unit 10 and the signal conveying apparatus 20 may alternatively be integrated in a single apparatus (as shown by a dashed rectangle in the drawing). The signal conveying apparatus 20 includes a transmitting unit 26. The transmitting unit 26 includes an output interface 261. The output interface 261 communicates with a first receiving interface 321 included in a first receiving unit 32 of the display device 30 via a transmission channel 40.

The signal conveying apparatus 20 further includes a second receiving unit 22 and a signal converting unit 24. The second receiving unit 22 is equipped with a plurality of input interfaces 221 (symbolically shown as A, B, C in the illustrated embodiment). The input interfaces 221 can be mechanical interfaces of a same type or of different types, each corresponding to a particular function. For example, in one exemplary application, a first one of the input interfaces 211 is an S-video (Separate Video) port, a second is a YPbPr port, a third is a YCbCr port, a fourth is a BNC port, and so on. The input interfaces 211 can alternatively be wireless receiving modules such as IR (infrared ray) receiving modules. Thereby, the input interfaces 211 are able to wirelessly receive signals from external electronic devices (not shown). The signal converting unit 24 converts signals received by the input interfaces 221 into a format capable of being received by the first receiving interface 321 of the display device 30. The converted signals are then conveyed to the display device 30 via a signal line symbolically shown as OL and the transmission channel 40.

The second receiving unit 22 also receives commands from the display device 30 via the transmission channel 40 and a control line symbolically shown as CL. The commands together with the signals received by the input interfaces 221 are transmitted from the second receiving unit 22 to the signal converting unit 24. The commands are used in the signal converting unit 24 to control the format conversion of the signals. According to the commands, the signal conveying apparatus 20 identifies what signal format is receivable by the first receiving interface 321 of the display device 30, and converts the signals into the receivable format.

The output interface 261 of the signal conveying apparatus 20 is preferably of the same type as the first receiving interface 321, so that the transmission channel 40 need only include a power line PL, a signal line OL, and a control line CL. Each of these lines is used to carry a corresponding transmission; i.e., electrical power, signals, and commands. The transmission channel 40 can alternatively be only a single conducting line. In such case, the single conducting line carries compound signals containing electric power, signals, and commands. In this description, it must be noted that the power line PL, the signal line OL, the control line CL, and the single conducting line are not to be construed as being limited to any specific form. These lines may be configured as desired in order to achieve their respective functions. That is, the power line PL can be of any form as long as it achieves power transfer. The signal line OL can be of any form as long as it achieves signal conveying. The control line CL can be of any form as long as it achieves command transmission. The single conducting line can be any form as long as it achieves all of power transfer, signal conveying, and command transmission.

Examples are given as follows to illustrate the signal conveying apparatus 20 in more detail.

In the examples, the input port A is an S-video port and is connected with a DV (digital vidicon), the input port B is a BNC (Bayonet Nut Connector) port and is connected with a DVD (digital video disc) player, and the transmitting unit 261 as well as the first receiving interface 321 are provided as YCrCb ports. The signal conveying apparatus 20 performs functions corresponding to this port configuration, exemplary details of which can include the following.

### EXAMPLE 1

In this example, only the DV outputs signals to the signal conveying apparatus 20, and the signals are in an S-video format. The display device 30 sends a command to the signal converting unit 24 to inform the signal conveying apparatus 20 of the receivable signal format, i.e., a YCrCb format. Then the signal conveying apparatus 20 converts the video signals from the S-video format into the YCrCb format, which can be received by the display device 30 via the YCrCb port. The display device 30 then receives the YCrCb formatted signals from the signal converting unit 24 via the first receiving interface 321, and displays media corresponding to the video signals provided by the DV.

A similar process as in Example 1) above occurs in the case that only the DVD player outputs signals to the signal conveying apparatus 20. Accordingly, a detailed description of such process is omitted herefrom.

### EXAMPLE 2

In this example, both the DV and the DVD player output video signals to the signal conveying apparatus 20. The signal conveying apparatus 20 combines the video signals from the DV with those from the DVD, and then converts the combined signal into the receivable YCrCb format of the display device 30. The signal conveying apparatus 20 can further divide the video signals in the S-video format and/or the BNC format into several parts, and select and combine one or more parts therefrom before the conversion into the YCrCb format is implemented. The converted video signals are output to the display device 30, which accordingly displays images combining information from the DV and the DVD player. For example, if the DV provides pictorial images and the DVD player provides captions, then the display device 30 displays the pictorial images with the captions.

Thus, via the signal conveying apparatus 20, a plurality of external electronic devices can be connected to the display device 30 for successful presentation of a variety of digital media. Further, via the signal conveying apparatus 20, signals from different information sources (e.g., the DV and the DVD player) can be integrated and converted into one format, and thus be displayed on the display device 30 simultaneously.

Similar to the above-described integration and conversion of video signals, audio signals can also be integrated and converted by the signal conveying apparatus 20. This can be done by equipping the signal conveying apparatus 20 with one or more audio interfaces (or audio/video interfaces). Further, audio signals can be integrated and converted with video signals by the signal conveying apparatus 20. This can be done by equipping the apparatus 20 with one or more audio/video interfaces.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A signal conveying apparatus, comprising:
a plurality of input interfaces, each for connecting with an electronic device and receiving signals therefrom;
an output interface for connecting with a display device, and for outputting signals to the display device in a format that the display device is capable of receiving; and
a signal converting unit for converting signals received by the input interfaces into the format that can be received by the display device, and for outputting the converted signals to the output interface.

2. The signal conveying apparatus according to claim 1, wherein the signal converting unit converts the signals from the input interfaces into the receivable format according to a command from the display device, the command being indicative of the receivable format.

3. The signal conveying apparatus according to claim 1, wherein the signal converting unit integrates the signals from more than one input interface before converting the signals into the receivable format.

4. The signal conveying apparatus according to claim 3, wherein the signal converting unit divides the signals from the input interfaces into several parts, and selects one or more parts to integrate.

5. The signal conveying apparatus according to claim 1, further comprising a power supply unit integrated therewith.

6. The signal conveying apparatus according to claim 5, wherein the power supply unit provides power to the display device.

7. A display system, comprising:
a display device comprising a receiving interface, the display device being capable of receiving signals of a certain format via the receiving interface; and
a signal conveying apparatus, comprising:
a plurality of input interfaces, each for connecting with an electronic device and receiving signals therefrom;
a signal converting unit for converting signals received by the input interfaces into the format receivable by the display device; and
an output interface connected with the signal converting unit and the display device, for outputting the converted signals from the signal converting unit to the display device.

8. The display system according to claim 7, wherein the display device sends a command indicative of the receivable format to the signal conveying apparatus, and the signal converting unit converts the signals from the input interfaces into the receivable format.

9. The display system according to claim 7, wherein the signal converting unit integrates the signals from more than one input interface before converting the signals to the receivable format.

10. The display system according to claim 9, wherein the signal converting unit divides the signals from the input interfaces into several parts, and selects one or more parts to integrate.

11. The display system according to claim 7, further comprising a power supply unit, wherein the signal conveying apparatus receives power from the power supply unit.

12. The display system according to claim 11, wherein the display device receives power from the power supply unit.
